(19) United States
(12) Patent Application Publication
(10) Pub. No.: US 2010/0139861 A1
(43) Pub. Date: Jun. 10, 2010

(54) SCENTED TATTOO PLASTER

(75) Inventors: Christian Hausen, St.Katharinen (DE); Christina Klein, Mayen (DE); Iris Schnitzler, Bonn (DE); Anja Tomeleri, Neuwied (DE)

Correspondence Address: FROMMER LAWRENCE & HAUG, 745 FIFTH AVENUE- 10TH FL., NEW YORK, NY, 10151, US

(73) Assignee: ICS Innovative Care Systems Andernach GmbH, Andernach (DE)

(21) Appl. No.: 12/628,396

(22) Filed: Dec. 1, 2009

(30) Foreign Application Priority Data
Dec. 1, 2008 (DE) 102008059727.9

(51) Int. Cl. B44C 1/165; G09F 3/00; B05D 5/00

(52) U.S. Cl. 156/344; 428/41.7; 427/258

(57) ABSTRACT

An article is disclosed which constitutes a multilayered plaster for application to the skin. It comprises an adhesive layer (1), a printed carrier layer (2), a coating layer (3) comprising at least one fragrance and a removable protective layer (4). In one particular embodiment, the fragrance is contained in microcapsules.

The present invention relates to a multilayered, scented tattoo plaster with directed, long-lasting fragrance delivery for application to the skin.

The invention furthermore relates to the production of this tattoo plaster and to its use.

U.S. Pat. No. 5,817,385 discloses a removable scented tattoo which combines visual and olfactory properties. The removable scented tattoo comprises a substrate layer (16) with a printed image (18) on one surface and an adhesive (20) on the opposing surface. A fragrance-containing layer (14) is applied to the tattoo. The tattoo is then applied to a body part in order to release the fragrance during the transfer of the tattoo to the body.

Here, one preferred embodiment of this article consists of a support layer (12) made of paper, plastic or the like which is coated with a removable tattoo layer (10), which in turn is coated with a layer (14) with fragrance-containing microcapsules. The tattoo layer (10) is a substrate (16) with a printed image (18) on one surface, and a pressure-sensitive adhesive (20) on the other surface of the substrate (16). The substrate (16) is preferably a film or a sheet material which is formed of any desired polymeric film, preferably a flexible, porous, nonwoven, compacted fabric or compacted fibrous material. The printed image (18) is formed of dyes and may be in a single colour or multiple colours. The adhesive (20) is preferably pressure-sensitive and moisture-permeable, for which, for example, acrylic and polyurethane pressure-sensitive adhesives are suitable. The fragrance-containing layer (14) comprises capsules in the order of magnitude of from 5 to 150 μm. The capsules can be prepared by standard methods.

In use, the tattoo (10) is applied to the skin by inverting the support layer (12), during which the fragrance-containing layer (14) and the tattoo layer (10) come into direct contact with the surface of the skin. Pressure is then applied to the outer surface (12a) of the support layer (12) in such a way that the microcapsules in the fragrance-containing layer (14) break open and the adhesive layer (20) attaches the substrate (16) and the printed image (18) to the surface of the skin.

In this way, as a result of the rubbing during transfer of the tattoo to the skin, the microcapsules in the fragrance-containing layer (14) are broken and the fragrance is released. The fragrance can then be detected with the olfactory senses over a certain period of time while the printed image offers the consumer a ready visual indicator of the name or brand of the fragrance.

The disadvantage of the articles described in U.S. Pat. No. 5,817,385 is that the fragrance release takes place as a result of mechanical stress (rubbing etc.) at the moment of applying the tattoo. The fragrance release is thus dependent on the number of microcapsules destroyed during the application. Consequently, however, the period of time over which the fragrance can be detected is also dependent on this.

It is an object of the present invention to provide a scented tattoo with a long fragrance release. In particular, the fragrance release should take place into the surrounding area and be able to be controlled by the user. Preferably, the fragrance release should be on demand, which should be possible through repeated activation of a renewed fragrance release following application of the tattoo.

The scented tattoo with a long fragrance release should also be able to be produced in a simple and cost-effective manner.

The object is achieved by a multilayered plaster for application to the skin, which has a) an adhesive layer (1), b) a printed carrier layer (2) and c) a coating layer (3) comprising at least one fragrance.

In one particular embodiment, the multilayered plaster for application to the skin can also comprise a removable protective layer (4) which covers the adhesive layer.

In a further particular embodiment, the fragrance in the coating layer comprising a fragrance may also be contained in microcapsules. In this form, the performance of the multilayered plaster is governed essentially by the life of the microencapsulated fragrance.

In a further embodiment, the multilayered plaster can be punched into an individual shape.

The object is furthermore achieved by a method of producing a multilayered plaster for application to the skin, which has a) an adhesive layer, b) a printed carrier layer and c) a coating layer comprising at least one fragrance, where this coating layer is applied to the carrier layer with the help of a printing process. The printing medium (=quasi the “printing ink”) here is a flowable mixture of the at least one fragrance and the coating.

Production of the multilayered plaster takes place here in a plurality of steps, a central step being the lamination of a first laminate and of a second laminate, where a permanent joining together over the entire area of the two previously produced laminates takes place.

The first laminate is a laminate of adhesive layer (1) and removable protective layer (4), where the adhesive layer may be equipped with a covering layer for storage purposes. The second laminate comprises the printed carrier layer (2) and the coating layer (3) comprising the at least one fragrance. Lamination of the two laminates takes place by firstly removing the optionally present covering layer from the first laminate. The adhesive layer of the first laminate is then brought into contact with the printed carrier layer (2) of the second laminate.

In the laminate material that is formed, pregiven contours can now be punched, projecting punch residues can be removed and the resulting individual multilayered plasters can be packaged.

In one preferred embodiment of this method, the fragrance is contained in microcapsules.

The use of a multilayered plaster for application to the skin, which has a) an adhesive layer, b) a printed carrier layer and c) a coating layer comprising at least one fragrance for a long fragrance release is, finally, a further solution according to the invention.

The adhesive layer (1) is the constituent of the multilayered plaster which effects adhesion of the plaster to the skin. The adhesive layer therefore preferably has pressure-sensitive adhesion. It is preferably a skin-compatible adhesive layer. “Skin-compatible” is understood as meaning that the material causes no skin irritations or allergies.

The adhesive layer has a thickness of from 40 to 100 μm, preferably from 60 to 70 μm. This layer thickness ensures that the multilayered plaster adheres securely to the skin, where necessary over a prolonged period.

Suitable materials for the adhesive layer are polymer materials, in particular poly(meth)acrylates, polyisobutylenes, polyterpenes (=polyisoprenes), ethylene-vinyl acetate copolymers, synthetic rubbers, styrene-isoprene-styrene block copolymers, styrene-butadiene-styrene block copolymers, hot-melt adhesives (here: in particular ethylene-vinyl acetate copolymers, vinylpyrrolidone-vinyl acetate copolymers, resins such as, for example, colophonium and its derivatives, waxes, such as, for example, natural beeswax or synthetic waxes), mixtures of rubbers and resins, silicone pressure-sensitive adhesives, polyvinyl acetate, polyvinylpyrrolidones, polyvinyl alcohols, polyethylene glycols, polyethylene oxides, cellulose derivatives (such as, for example, hydroxypropylmethylcellulose) and mixtures of these polymers.

Some of these specified polymer materials naturally have pressure-sensitive adhesion, some only produce pressure-sensitive adhesive formulations as a result of the addition of suitable auxiliaries (e.g. tackifiers). Pressure-sensitive adhesive formulations of this type based on the specified polymer materials are known in principle to the person skilled in the art and are commercially available. The polymer materials are obtainable in this form as straight substance, as water-based dispersion or in solution of an organic solvent.

Particularly preferred materials for the adhesive layer are poly(meth)acrylates and ethylene-vinyl acetate copolymers.

The adhesive layer can also comprise one or more known auxiliaries, in particular those from the groups of plasticizers, emulsifiers, tackifiers, solubility promoters, stabilizers, fillers and carriers.

The adhesive layer preferably has a polymer fraction of from 10 to 100% by weight, in particular 70 to 100% by weight; the auxiliaries fraction is preferably between 0.1 and 30% by weight, in particular between 0.1 and 10% by weight.

The adhesive layer ensures that the multilayered plaster adheres to the skin for at least 6 hours. However, in certain circumstances, it is also possible for the multilayered plaster to adhere to the skin for several, i.e. at least two, days on account of the adhesive properties of the adhesive layer.

The adhesive layer (1) is produced according to the polymer material used. For this, the removable protective layer (4) is coated with a solution or dispersion of the polymer material and any auxiliaries contained therein and the solvent is removed by heating in the drying tunnel. A laminate composed of removable protective layer (4) and adhesive layer (1) is formed. Another option is to melt the polymer material and any auxiliaries contained therein by heating and to spread out the resulting flowable mixture on the removable protective layer. Upon cooling, solidification of the melt takes place, and a laminate of removable protective layer (4) and adhesive layer (1) is formed. For better storage, the laminates produced in this way can be provided with a covering layer.

A printed carrier layer (2) is understood as meaning a constituent which has a particular strength and imparts dimensional stability to the multilayered plaster. It can therefore also be regarded as a support layer. The printed carrier layer can be composed of a “skin-compatible”plastics material. The printed carrier layer is preferably a film.

Within the context of this description, “printed” as an adjective with regard to the carrier layer means that the carrier layer has a single-coloured or multicoloured image which constitutes the visually detectable image of the tattoo. This image can be specific or abstract, contain lettering or be a logo.

Suitable materials for the printed carrier layer are films made of polyester (PE), such as, for example, polyethylene terephthalate (PET) and polybutylene terephthalate (PBT), but also those made of polyvinyl chloride (PVC), ethylene-vinyl acetate copolymers (EVA), polyvinyl acetate (PVA), polylactic acid (PLA), polyethylene (PE), polypropylene (PP; here in particular oriented polypropylene OPP and biaxially oriented polypropylene BOPP), polyurethane (PU), cellulose derivatives and others. Preference is given to films made of polyester (PE, PET and PBT) and polypropylene (PP, OPP and BOPP).

Preference is given to films made of materials which have a barrier effect with regard to perfume and fragrances.

The printed carrier layer has a thickness of from 9 to 60 μm, preferably from 12 to 25 μm.

In one preferred embodiment, the printed carrier layer has a metal layer which is preferably applied by vapour deposition. A suitable metal for this is in particular aluminium. This metal layer is preferably located only on the surface of the film. This is the surface of the carrier layer (2) which faces the adhesive layer (1) in the multilayered plaster.

According to the definition, this surface of the carrier layer provided with a metal layer is referred to in this description as “inside” (2i), whereas the opposing surface of the carrier layer is therefore referred to as “outside” (2a).

The outside of the carrier layer (2a) has the single-coloured or multicoloured image. Preferably, this outside (2a) is subjected to corona treatment. This is a surface treatment which can increase the polarity of the surface and can thus lead to an improvement in the wettability and the chemical affinity. Corona treatment can be carried out continuously at the end of the manufacturing process during film production. Preferably, however, corona treatment takes place directly prior to the printing of the outside (2a) with the image.

A particularly suitable carrier layer (2) is a film made of polyethylene terephthalate (PETP) with a layer thickness of less than 25 μm which has been vapour-deposited on the inside (2i) with aluminium and has been prepared on the outside (2a) by corona treatment. Directly prior to the printing of the outside (2a), a “freshening up” can take place through a further corona treatment.

Another particularly suitable carrier layer (2) is a film made of oriented polypropylene (OPP) with a layer thickness of greater than 15 μm which has been vapour-deposited on the inside (2i) with aluminium and has been prepared on the outside (2a) by corona treatment. This film has to be subjected to corona treatment directly prior to printing the outside (2a).

The coating layer (3) comprising a fragrance is the element of the multilayered plaster which, following its application, is intended to ensure fragrance release into the surrounding area. The coating layer is located on the side of the printed carrier layer facing away from the adhesive layer. Preferably, the coating layer comprising the fragrance is directly on the printed carrier layer.

The coating layer is composed of a coating and comprises at least one fragrance. Here, the fraction of the fragrance in this layer can be between 0.1 and 60% by weight, preferably between 1 and 20% by weight. The fraction of the fragrance here is essentially determined by the intended use of the multilayered plaster.

Within the context of the present description, a coating is understood as meaning a liquid, paste-like or pulverulent coating substance which, applied to a substrate, produces a covering coating. Preferably, for producing the coating layer (3), a nonpigmented coating substance is used, which is also referred to by the term clearcoat.

Suitable materials for the coating are printing varnishes, in particular water-based printing varnishes. These coatings are based on acrylate resin emulsions, which dry as a result of the vaporization of water and precipitation of the resins within a short time, i.e. within seconds. Higher gloss values can be achieved using UV-curing coatings. Here, photo-initiators are added to the acrylate resin emulsion and these bring about a crosslinking of the acrylate oligomers as a result of UV irradiation. The drying takes place here even more quickly, i.e. within fractions of a second. Preference is given to a water-based printing varnish from Ruco, Rupf & Co., Glattbrugg (Switzerland), with the name WD011422.

The coating layer (3) comprising at least one fragrance is prepared by incorporating the at least one fragrance into the coating and then printing a substrate using the resulting mixture. Here, the fragrance can also be used in the form of microcapsules comprising fragrance. The substrate used is preferably the printed carrier layer (2), in particular outside (2a) of the carrier layer.

In the multilayered plaster, the coating layer (3) comprising the at least one fragrance has a thickness which is as thin as possible and as thick as necessary. This means that—the thinner the coating layer (3)—the more flexible the multilayered plaster can be. The thickness of the coating layer (3) can therefore be between 5 and 20 μm, preferably between 6 and 12 μm.

The layer thickness of the coating layer (3) can be varied by adjusting the coating height.

The removable protective layer (4) may be present in the article in order to cover the adhesive layer and thus to prevent undesired adhesion. Prior to using the multilayered plaster, the removable protective layer is removed from the adhesive layer and the remaining product is applied to the skin using the adhesive layer.

The removable protective layer is in the form of a film. It can have a thickness of up to 150 μm or more. Preferably, the thickness of the protective layer (4) is in the range from 75 to 100 μm. Generally, a film with a relatively large thickness is selected as removable protective layer (4) since this improves the processability of the other layers of the multilayered plaster. Since, prior to the application of the multilayered plaster on the skin, the protective layer (4) is removed from this and discarded, this constituent of the multilayered plaster is also not further critical for the use of the other layers as scented tattoo plaster.

For the removable protective layer (4), it is possible to use the same materials as for the carrier layer (2). In contrast to the carrier layer, the protective layer is subjected to another surface treatment, e.g. a siliconization or a fluorosiliconization. This gives the corresponding surface of the protective layer (4) an antiadhesive finish. Removable protective layers that can be used are, however, also polytetrafluoroethylene-treated paper, cellophane, polyvinyl chloride, polystyrene or the like.

Removable protective layers are commercially available, such as, for example, the films from Siliconature known under the name Silphan®.

The at least one fragrance is contained in the multilayered plaster in order to ensure olfactory detection.

The (at least one) fragrance is a single, defined chemical compound with an odour (odorant), which preferably triggers a pleasant odour sensation in people and therefore finds diverse use for the perfuming of industrial and sanitary articles, soaps, cosmetics, body care compositions and the like.

Within the context of the present description, however, essences (an aroma extract usually obtained by alcoholic distillation) and aromas (industrially produced aromas, which are precisely defined in chemical terms, namely (1) natural aroma substances, (2) nature-identical aroma substances, (3) artificial aroma substances, (4) aroma extracts, (5) reaction aromas and (6) smoke aromas) are also types of fragrances.

The aroma extracts also include essential oils, i.e. concentrates obtained from plants which are used as natural raw materials primarily in the perfume and food industries and which consist of volatile compounds which are prepared from plant raw materials by steam distillation.

In order to be able to be detected by smell, fragrances must satisfy certain molecular prerequisites: low molar mass (maximum 300 g/mol) with a correspondingly high vapour pressure, surface activity, minimal water and high lipid solubility, and weak polarity. A strongly hydrophobic and a weakly polar molecular moiety generally suffice to trigger sensory activity. The presence of an osmophoric group, such as, for example, a part structure with —OH, —OR, —CHO, —COR, —COOR (euosmophores), can bring about a pleasant odour effect. In addition, the stereochemistry, i.e. the spatial configuration of the molecules, plays an important role for the properties of a substance as fragrance.

The fragrances include: terpenoids, pyrocatechin derivatives, phenol derivatives, other aromatics, aliphatics, alicyclics and heterocyclics.

However, fragrances are differentiated not only according to their chemical structure, but also according to their odour properties. A systematic arrangement takes place here not according to chemical structural features, but according to odour characteristics. They are arranged according to “scent families” and according to characteristic scent notes.

TABLE
Odour classes (according to Römpp
online, document RD-18-01394, December 2007)

| Odour class | Odour characterization | Typical examples |
|---|---|---|
| Floral | Flower odours (rose, | Geraniol, ionone |
| | jasmine etc.) | |
| Citrus | Resembling citrus | Citral |
| | fruits | |
| Green | Grass, green leaves | Hex-3-en-1-ol |
| Herbaceous | Green (pot) herbs | Thujone |
| Minty | Peppermint, spearmint | Menthone, (−)-carvone |
| Camphorous | Celluloid, earthy | Camphor |
| Aldehyde | Greasy, waxy, ozone- | Alkanals and alken-1- |
| | like, watery | als C8-C13 |
| Fruity | Fruit odours | Fruit esters, |
| | | lactones |
| Sweet | Resembling resins and | Vanillin |
| balsamic | chocolate | |
| Spicy | Spice notes | Eugenol |
| Woody | Resembling fine wood: | Santalol, cedrol |
| | cedar, sandalwood | |
| Animalic | Musk, amber, cibet | Muscone, amber oxide, |
| | | clary sage oil, civet |

For the coating layer comprising the at least one fragrance, suitable fragrances are in particular those which have a boiling point above 100° C. These are in particular essential oils, i.e. mixtures of volatile components which are prepared by steam distillation from vegetable raw materials.

Essential oils (“scent oils”) of this type generally consist of volatile components whose boiling points are primarily between 150 and 300° C. They comprise predominantly hydrocarbons or monofunctional compounds, such as aldehydes, alcohols, esters, ethers and ketones. Parent compounds are monoterpenes and sesquiterpenes, phenylpropane derivatives and relatively long-chain aliphatic compounds. Essential oils are accordingly relatively nonpolar mixtures, i.e. they are soluble in most organic solvents. For many of the commercially significant essential oils, the number of identified components is in the hundreds.

Essential oils are in particular those which are obtained from field mint, agar wood, angelica root, anise, amyris, arnica, baldrian, basil, bay, mugwort, benzoin, bergamot, birch, bitter orange, blue camomile, blood orange, savory, bucco leaves, cajeput, calendula, cananga, cascarilla, cassia, cistus, citronella, clementine, copaiva, costus root, davana, dill, Douglas-fir, noble fir, oak moss, verbena, elemi, gentian, tarragon, eucalyptus, fennel, spruce, galbanum, galangal, curcuma, geranium, ginger grass, broom, golden rod, grapefruit, green anise, guaiac wood, gurjun balsam, honey, hops, hyacinths, immortelle, ginger, iris, jasmine, St. John's wort, cocoa, calmus, camomile, camphor, kanuka, cardamom, carrot, pine needle, garlic, coriander, spearmint, cumin, caraway, larch, dwarf pine, lavandin, lavender, lavender spica, lemongrass, lovage, lime, linaloe, litsea, laurel, mace, magnolia, cinnamon rose, marjoram, mandarin, mandarin wood, manuka, maritime pine, melissa, mimosa, musk seeds, clary sage, nutmeg, myrrh, myrtle, nagarmotha, nard, narcissus, clove, neroli, niaouli, orange, origanum, palmarosa, patchouli, Peru balsam, parsley, petit grain, pepper, peppermint, pimento, pennyroyal, wild thyme, tansy, rue, ravensara, ravintsara, rose, rosewood, rosemary, Roman camomile, sage, sandalwood, santolin, sassafras, yarrow, French lavender, celery, siam wood, styrax, tobacco, tagetes, fir cones, tea tree oil, terpentine, thuja, thyme, tolu balsam, tonka tonka, tuberose, vanilla, violet, vetiver, juniper, frankincense, silver fir, absinthe, meadowsweet, wintergreen, wormseed, ylang ylang, hyssop, cedar, cinnamon, Swiss pine, lemon, citronella grass, onion and cypress.

In a further preferred embodiment, use is made in particular of those fragrances which have no or only slight solubility in water. Furthermore, preference is given to fragrances which have no alcoholic hydroxyl group.

Particularly preferred fragrances are the fragrances and perfumes known in fine perfumery (“fine fragrance”).

In the case of fragrances which have a boiling point lower than 100° C., or those which are soluble in water, the addition of odour-neutral, difficultly volatile oils such as paraffins, alkylaromatics, esters or polyethylene glycols, can make it possible for them to be used in the fragrance-containing coating layer (3).

Preferably, the fragrances used are also mixtures of fragrances which are referred to in the cosmetics industry as perfumes or perfume oils.

As already mentioned, in a further particular embodiment, the fragrance in the coating layer comprising at least one fragrance may be contained in microcapsules. Methods of producing microcapsules filled with fragrance are disclosed in U.S. Pat. No. 3,516,941, U.S. Pat. No. 4,082,688, U.S. Pat. No. 4,277,364, U.S. Pat. No. 4,808,408, U.S. Pat. No. 5,043,161 and U.S. Pat. No. 5,051,305, to the entire contents of which reference is hereby made.

The microcapsules are hollow spheres which have a hard shell (“capsule wall”) and can have a diameter between 5 and 80 μm. However, the microcapsules usually have a diameter below 30 μm, preferably between 6 and 15 μm. The at least one fragrance and optionally further substances are present inside the microcapsules.

The size of the microcapsules can be adjusted steplessly during production, which is influenced by the size of the droplets of the at least one fragrance, which is present as oil-in-water emulsion in the reaction mixture. For the further processing, the resulting microcapsules, however, may also be given by filters with a corresponding pore size.

In one particular embodiment, the capsule wall of these hollow spheres consists of a material that is impermeable for the fragrance, which prevents evaporation of the fragrance located inside the microcapsules. In this case, the fragrance can only be released from the multilayered plaster following a preceding mechanical destruction of the microcapsules.

However, for the capsule wall, it is also possible to use materials which have a certain permeability for the fragrance located inside the microcapsules. Such embodiments permit a time-delayed release of the fragrance from the fragrance-containing coating layer (3).

Suitable materials for the capsule walls are thermosets. These are plastics which are formed as a result of irreversible and close-meshed crosslinking via covalent bonds from prepolymers, more rarely from monomers or polymers. The word “thermoset” is used here both for the raw materials prior to crosslinking (reaction resins) and also as a collective term for the cured, in most cases completely amorphous resins.

Thermosets are energy-elastic at low temperatures, and even at higher temperatures they are unable to flow in a viscous manner, but behave in an elastic manner with very limited deformability. Thermosets include, inter alia, the industrially important substance groups of the diallyl phthalate resins (DAP), the epoxy resins (EP), the urea-formaldehyde resins (UF), the melamine-formaldehyde resins (MF), the melamine-phenol-formaldehyde resins (MPF), the phenol-formaldehyde resins (PF) and the unsaturated polyester resins (UP).

The materials used must be acceptable from a toxicological point of view, which is ensured in the case of the specified thermosets. The capsule wall material cannot be attacked bacterially and consequently cannot be a nutrient medium for microorganisms.

Particular preference is given to melamine-formaldehyde resins, the curable condensation products of melamine and formaldehyde belonging to the aminoplasts. Firstly, the melamine reacts with this aldehyde under acid or base catalysis to give N-methylol compounds. Upon a prolonged reaction time or at elevated temperature, the methylol groups then react with further melamine to form methylene bridges or—in the case of reactions of methylol groups with one another—methylol ether bridges. However, before these processes can lead to a close-meshed crosslinked, very hard, thermally resistant and completely insoluble resin, the reaction is usually stopped at the stage of still soluble or meltable precondensates in order to mix in fillers. To improve the solubility of these precondensates, some of the methylol groups still present can additionally be etherified.

The final curing of the melamine-formaldehyde resins, including the modified ones, then takes place in practice almost without exception at elevated temperature, i.e. above 100° C., and primarily in the presence of acidic accelerators. It proceeds with the elimination of water and formaldehyde (in the case of etherified products also with the release of alcohol) to give thermosets crosslinked irreversibly via methylene bridges and/or methylene ether bridges.

A further preferred capsule wall material can be produced through coacervation of gelatin, albumin or casein with cellulose derivatives such as methylcellulose, ethylcellulose, cellulose acetate, cellulose nitrate or carboxymethylcellulose (CMC) and a synthetic polymer such as polyamides, polyethylene glycols, polyacrylic acid copolymers, polyurethanes, epoxy resins and in particular maleic anhydride, copolymers of maleic anhydride, such as, for example, polyvinyl methyl ether/maleic anhydride copolymer (PVMMA) and ethylene-maleic anhydride copolymer (EMA). Particular preference is given to gelatin/polyvinyl methyl ether-maleic anhydride copolymer/carboxymethyl-celluose as capsule wall material.

The microcapsules are heat-resistant up to 140° C., in the short term even up to 170° C.

By varying the wall thickness it is possible to influence the release properties of the microcapsules in a simple manner. Thus, microcapsules can be produced which continuously deliver fragrance over a long period, but also practically odourless leathers, which only release the fragrance upon mechanical stress.

Preferred wall thicknesses of the microcapsules containing at least one fragrance are in the range from 2-25% by weight, preferably 3-15% by weight, in particular 4-10% by weight of capsule wall material, in each case based on the total weight of the microcapsules. The term “wall thickness” is to be understood here as meaning the quantitative fraction of the capsule wall material based on the total weight of the microcapsules.

The microcapsules have a certain pressure stability and can therefore be used very readily for the printing of substrates. In this connection, the microcapsules are applied in the form of a flowable mixture, preferably as a printing paste. The certain pressure stability ensures that the microcapsules are not destroyed, or are only destroyed to a slight degree, during the corresponding printing process. Upon mechanical stressing of the fragrance-containing coating layer (3) by the consumer, for example by rubbing, the micro-capsules contained in this layer are disrupted and the fragrance is released.

In particular embodiments, the microcapsules may also be perforated capsules or depot capsules. Here, a perforated capsule is understood as meaning a microcapsule in which the capsule wall is not completely closed, but has openings which facilitate escape of the fragrance contained in the microcapsules. A depot capsule is understood as meaning a microcapsule which, in addition to the at least one fragrance, comprises a carrier material which brings about a time-delayed release of the fragrance.

The preparation of the microcapsules takes place by the coacervation known to the person skilled in the art or using the oil-in-water method.

The method for producing multilayered plasters with a coating layer containing at least one fragrance is characterized in that this coating layer is applied to the carrier layer with the help of a printing process. The printing medium here is a flowable mixture of the at least one fragrance and the coating.

For producing the coating layer it is in principle possible to use all known printing principles, although “flat against round” and “round against round” are preferred. “Flat against round” is understood here as meaning the principle, as a result of the rotational movement of an impression cylinder on the printing form, of exerting a printing pressure on the print material. In the case of the “round against round” principle, the printing operation functions via two cylinders. The print material is pressed over a counter-impression cylinder on the engraved cylinder and printed in this way.

Particularly suitable printing processes are all high-pressure processes which are known to the person skilled in the art and which can be carried out with suitable printing machines. These machines include: (1) platen presses, (2) stop cylinder high-speed presses, (3) rotary machines and (4) Cameron high-pressure roll presses. However, intaglio processes are also suitable for producing the fragrance-containing coating layer.

A particularly suitable form of a high-pressure process is flexographic printing. This is a roll rotary printing process in which the flexible carrier layer is printed with the printing medium (i.e. a flowable mixture of fragrance and coating). Since in flexo-graphic printing a short inking system without numerous rolls is used, it is likewise related to the intaglio process. In this type of printing, the printing medium can also be applied to the carrier layer through a half-tone roll (half-tone flexographic printing).

As stated, the printing medium is a flowable mixture of the at least one fragrance and the coating. This mixture can optionally comprise additives such as coloured pigments, solvents, other auxiliaries, drying accelerators such as, for example, alcohols, drying retardants such as, for example, glycols, additives for abrasion resistance, flexibility and slip behaviour such as, for example, waxes, and also binders such as, for example, soluble resins. Preferably, the printing medium is free from coloured pigments.

In the printing medium, the fragrance can be present in a concentration up to 35% by weight. Preferably, the content is between 1 and 30% by weight, particularly preferably between 5 and 25% by weight.

If the fragrance is present in microcapsules, its content in the printing medium can significantly increase. Microcapsules filled with fragrance may be present in the printing medium in a fraction of up to 55% by weight, preferably between 2 and 35% by weight and particularly preferably between 10 and 30% by weight.

The density of the printing medium can be altered by adding fragrance-containing microcapsules. It can be between 650 and 1400 kg m⁻³, preferably between 850 and 1200 kg m⁻³.

The amount of fragrance transferred during the printing process depends primarily on the concentration of the fragrance or on the concentration of the microcapsules containing at least one fragrance in the printing medium. However, the fineness of the half-tone rolls and the layer thickness also influence the amount of fragrance per multilayered plaster.

The coating layer (3) containing the at least one fragrance should generally be carried out over the fewest possible sharp edges or between rolls since every mechanical stress could bring about rupture of the microcapsules and thus premature release of the perfume. The separate production of two laminates, where the first laminate comprises the adhesive layer (1) and the removable protective layer (4) and the second laminate comprises the printed carrier layer (2) and the fragrance-containing coating layer (3), and the lamination of these two laminates provide here for a particularly gentle production of the multilayered plaster.

The multilayered plaster for application to the skin, which comprises a) an adhesive layer, b) a printed carrier layer and c) a coating layer comprising at least one fragrance, can be used for releasing the fragrance into the surrounding area, particularly after it has been stuck to the skin of a user. In so doing, the skin does not come into contact with the coating layer (3) containing the at least one fragrance.

In one preferred embodiment, the actual fragrance release takes place as a result of mechanical stressing by the user who, for this purpose, disrupts microcapsules in the coating layer which comprise the at least one fragrance, for example by rubbing.

Preferably, the fragrance release can be on demand, which, following application of the multilayered plaster, is possible via more than a single mechanical stressing by the user.

Following a single mechanical stressing, the release of the fragrance can last up to 2 hours, preferably up to 6 hours. Here, the period of fragrance release can be prolonged by a further mechanical stressing and with an associated disruption of the microcapsules.

Apart from on the skin, the article according to the invention can of course also be stuck to other surfaces, for example to textiles, furniture, jewelry, paper etc.

### Examples of the Production

### Example 1

130 g of a 50% strength solution of Durotak 387-2287 in ethyl acetate are applied to a 760 mm wide web of Silphan 100 μm with an areal weight of 140 g/m². After removing the solvent in the drying tunnel at a temperature of 30 to 90° C., a 65 μm thick adhesive layer (1) is formed, which is covered with an HDPE film. In this first laminate, the web made of Silphan serves as the removable protective layer (4) for the multilayered plaster.

To produce the microcapsules, 1 kg of perfume oil is mixed with capsule material. Stirring produces a fine dispersion. 800 g of microcapsules are formed having a diameter of 8 μm, which are added to 3.12 kg of water-based coating. This gives 3.2 kg of a pasty mass, which can be used below as printing medium.

In a further process step, a PET film with a width of 760 mm and aluminized on one side is used as printed carrier layer (2). The previously prepared, microcapsule-containing printing medium is now applied to the printed side (2a) in a layer thickness of 0.01 mm. The water present therein is removed by gentle drying. This gives a second laminate of printed carrier layer (2) and a fragrance-containing coating layer (3), which has therein a layer thickness of 30 μm.

The HDPE film serving as covering layer is then removed from the first laminate and the free adhesive layer is stuck onto the aluminized inside (2i) of the PET film of the second laminate that is aluminized on one side.

In the article which is formed, contours are now punched in such a way that the removable protective layer is not cut through. Projecting punch residues are removed. Following this “fencing off”, the removable protective film (4) provided with the contoured individual multilayered plaster is cut crossways, placed onto a lower packaging web, covered with an upper packaging web and conveyed to a sealing station. Sealed sachets which contain at least one multilayered plaster are obtained.

### DESCRIPTION OF THE FIGURES

FIG. 1 shows the schematic construction of a multi-layered plaster in cross section.

FIG. 2 shows a multilayered plaster in top view. Layers (1) to (3) are congruent and form the shape of a motif. The protective layer (4) is rectangular.

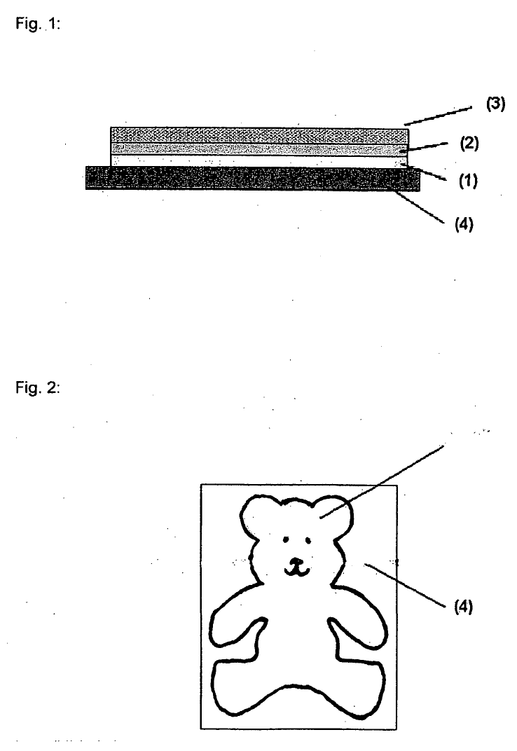

### LIST OF REFERENCE NUMBERS

In the figures, the numbers have the following meaning:
(1)=Adhesive layer
(2)=Printed carrier layer
(3)=Coating layer containing fragrance
(4)=Removable protective layer

1. Multilayered plaster for application to the skin, which comprises an adhesive layer (1), a printed carrier layer (2), a coating layer (3) comprising at least one fragrance and a removable protective layer (4).

2. Article according to claim 1, characterized in that the at least one fragrance is contained in microcapsules.

3. Article according to claim 1, characterized in that the printed carrier layer (2) has an inside (2i) which is aligned with the adhesive layer (1), and an outside (2a) which is aligned with the coating layer (3).

4. Article according to claim 1, characterized in that the adhesive layer comprises at least one polymer material from the group of poly(meth)acrylates, polyisobutylenes, poly-terpenes, polyisoprenes, ethylene-vinyl acetate copolymers, synthetic rubbers, styrene-isoprene-styrene block copolymes, styrene-butadiene-styrene block copolymers, hot-melt adhesives, vinylpyrrolidone-vinyl acetate copolymers, resins, waxes, mixtures of rubbers and resins, silicone pressure-sensitive adhesives, polyvinyl acetates, polyvinylpyrrolidones, polyvinyl alcohols, polyethylene glycols, polyethylene oxides and cellulose derivatives.

5. Article according to claim 1, characterized in that the printed carrier film is a film made of polyester (PE), polyethylene terephthalate (PET), polybutylene terephthalate (PBT), polyvinyl chloride (PVC), ethylene-vinyl acetate copolymers (EVA), polyvinyl acetate (PVA), polylactic acid (PLA), polyethylene (PE), polypropylene (PP), polyurethane (PU), cellulose derivatives or a laminate made of at least one of these materials.

6. Article according to claim 1, characterized in that the coating layer is prepared from a printing varnish.

7. Article according to claim 6, characterized in that the coating layer is prepared from a water-based printing varnish.

8. Article according to claim 1, characterized in that the fragrance is a single, defined chemical compound with an odour, or at least one essence or at least one aroma substance.

9. Article according to claim 2, characterized in that the microcapsules are prepared from a thermoset.

10. Article according to claim 9, characterized in that the thermoset is a substance from the group consisting of diallyl phthalate resins (DAP), epoxy resins (EP), urea-formaldehyde resins (UF), melamine-formaldehyde resins (MF), melamine-phenol-formaldehyde resins (MPF), phenol-formaldehyde resins (PF) and the unsaturated polyester resins (UP).

11. Method of producing an article of claim 1 which comprises an adhesive layer (1), a printed carrier layer (2) and a coating layer (3) comprising at least one fragrance and a removable protective layer (4), characterized in that the coating layer (3) comprising the at least one fragrance is applied to the printed carrier layer (2) by means of a printing process.

12. Method according to claim 11, characterized in that the printing process used is a high-pressure process.

13. Method according to claim 12, characterized in the at the printing process use is flexographic printing.

14. A method of releasing fragrance into the surrounding area which comprises of exposing an article comprising an adhesive layer (1), a printed carrier layer (2) and a coating layer comprising at least one fragrance to the surrounding area.
